(19) United States
(12) Patent Application Publication
(10) Pub. No.: US 2014/0013389 A1
(43) Pub. Date: Jan. 9, 2014

(54) COMMUNICATION BLOCKING CONTROL APPARATUS AND METHOD THEREOF

(71) Applicants: Byoung-Jin HAN, Suwon-si (KR); Deok-Jin KIM, Daejeon (KR); Chul-Woo LEE, Daejeon (KR); Man-Hee LEE, Daejeon (KR); Byung-Chul BAE, Daejeon (KR); Hyung-Geun OH, Daejeon (KR); Ki-Wook SOHN, Daejeon (KR)

(72) Inventors: Byoung-Jin HAN, Suwon-si (KR); Deok-Jin KIM, Daejeon (KR); Chul-Woo LEE, Daejeon (KR); Man-Hee LEE, Daejeon (KR); Byung-Chul BAE, Daejeon (KR); Hyung-Geun OH, Daejeon (KR); Ki-Wook SOHN, Daejeon (KR)

(73) Assignee: ELECTRONICS AND TELECOMMUNICATIONS RESEARCH INSTITUTE, Daejeon (KR)

(21) Appl. No.: 13/615,942

(22) Filed: Sep. 14, 2012

(30) Foreign Application Priority Data
Jul. 5, 2012 (KR) 10-2012-0073477

(51) Int. Cl. G06F 21/20

(52) U.S. Cl. 726/3

(57) ABSTRACT

A communication blocking control method includes receiving a communication blocking request from a terminal in an idle state in which it is difficult to find out whether information is leaked or not; registering a state of the terminal in a communication blocked list according to the communication blocking request; and blocking external communication of the terminal through a network.

### CROSS-REFERENCE(S) TO RELATED APPLICATIONS

This application claims priority to Korean Patent Application No. 10-2012-0073477 filed on Jul. 5, 2012, which is incorporated herein by reference in its entirety,

### BACKGROUND OF THE INVENTION

1. Field of the Invention

Exemplary embodiments of the present invention relate to a communication blocking control apparatus and method; and, particularly, to an apparatus and method for controlling a function of blocking communication using an IDS (Intrusion Detection System)/IPS (Intrusion Prevention System) and a CAPTCHA (Completely Automated Public Turing test to tell Computers and Humans Apart), in order to prevent information from being leaked to the outside from a terminal while a user does not use the terminal.

2. Description of Related Art

With the spread of the Internet and various application fields using networks, the technology for managing networks has become a basis of information technology (IT). In particular, as the interest in security increases, much attention has been paid to a network access control technology capable of increasing security by controlling the network use of users according to various security policies.

Conventional network access control technologies have used a method in which a centralized server checks the states of terminals forming the entire network, and fundamentally blocks the communication of a terminal having a problem found therein through ARP modulation or the like. In this method, specific rules are adopted, and the server unilaterally blocks a terminal through detection.

Korean Patent No. 0432675 discloses a method which forcibly applies rules for communication permission or regulation for network internal equipments, and constructs an environment such as a virtual firewall between the network internal equipments.

The conventional network access control technologies have an advantage in that they can fundamentally block the communication of a terminal having a problem found therein, thereby preventing security threats such as a virus from spreading. However, a new rule must be adopted each time, and a problem may be found after information is sent to the outside. Furthermore, the corresponding terminal must be accessed off-line, in order to perform an operation of curing and correcting the terminal.

### SUMMARY OF THE INVENTION

An embodiment of the present invention is directed to an apparatus and method for controlling a function of blocking communication using an IDS/IPS and a CAPTCHA, in order to prevent information from being leaked to the outside from a terminal while a user does not use the terminal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a communication blocking control method includes: receiving a communication blocking request from a terminal in an idle state in which it is difficult to find out whether information is leaked or not; registering a state of the terminal in a communication blocked list according to the communication blocking request; and blocking external communication of the terminal through a network.

In blocking the external communication of the terminal through the network, the external communication of the terminal may be blocked based on an IDS/IPS.

When a screen saver of the terminal is operated or no input is made from a user of the terminal during a preset time, the terminal may determine that the terminal is in an idle state.

In accordance with another embodiment of the present invention, a communication blocking control method includes: receiving a communication blocking cancellation request from a terminal of which an idle state is ended, wherein the idle state corresponds to a state in which it is difficult to find out whether information is leaked or not generating a CAPTCHA corresponding to a recognition reaction of a user of the terminal, based on the communication blocking cancellation request; transferring the CAPTCHA to the terminal, and receiving a CAPTCHA response corresponding to the CAPTCHA; comparing the CAPTCHA response to a CAPTCHA list corresponding to the CAPTCHA; and controlling external communication of the terminal through a network, based on a result obtained by comparing the CAPTCHA response to the CAPTCHA list.

The CAPTCHA may include a test for determining whether the communication blocking cancellation request corresponds to a normal communication blocking cancellation request or not, through the recognition reaction of the user of the terminal.

In controlling the external communication of the terminal through the network, based on the result obtained by comparing the CAPTCHA response to the CAPTCHA list, when the CAPTCHA response is included in the CAPTCHA response list, the external communication of the terminal through the network may he controlled to be enabled.

In controlling the external communication of the terminal through the network, based on the result obtained by comparing the CAPTCHA response to the CAPTCHA list, when the CAPTCHA response is included in the CAPTCHA response list, the terminal may be deleted from a preset communication blocked list, according to the communication blocking cancellation request.

In controlling the external communication of the terminal through the network, based on the result obtained by comparing the CAPTCHA response to the CAPTCHA list, the external communication of the terminal through the network may be controlled based on an IDS/IPS.

In accordance with another embodiment of the present invention, a communication blocking control apparatus includes: a communication controller configured to receive a communication blocking request or communication blocking cancellation request from a terminal; and a state controller configured to register a state of the terminal as a communication blocked state or cancel the communication blocked state, according to the request received by the communication controller, wherein, when receiving the communication blocking cancellation request, the communication controller generates a CAPTCHA corresponding to a recognition reaction of a user of the terminal, based on the communication blocking cancellation request, receives a CAPTCHA response corresponding to the CAPTCHA from the terminal, and controls external communication of the terminal through a network to be enabled, based on a result obtained by comparing the CAPTCHA response to a CAPTCHA list corresponding to the CAPTCHA.

When the request received by the communication controller corresponds to the communication blocking request, the state controller may register the state of the terminal in a communication blocked list according to the communication blocking request, and perform control to block the external communication of the terminal.

The state controller controls the state of the terminal based on an IDS/IPS.

The CAPTCHA may include a test for determining whether the communication blocking cancellation request corresponds to a normal communication blocking cancellation request or not, through the recognition reaction of the user of the terminal.

### BRIEF DESCRIPTION OF THE DRAWINGS

FIG. 1 schematically illustrates an environment to which a communication blocking control apparatus in accordance with an embodiment of the present invention is applied.

FIG. 2 is a configuration diagram of the communication blocking control apparatus in accordance with the embodiment of the present invention.

FIG. 3 is a flow chart showing a method for controlling a communication blocked state of a terminal in accordance with the embodiment of the present invention.

FIG. 4 is a flow chart showing a method for controlling a communication blocking cancellation state of a terminal in accordance with the embodiment of the present invention.

### DESCRIPTION OF SPECIFIC EMBODIMENTS

Exemplary embodiments of the present invention will be described below in more detail with reference to the accompanying drawings. The present invention may, however, he embodied in different forms and should not be construed as limited to the embodiments set forth herein. Rather, these embodiments are provided so that this disclosure he thorough and complete, and will fully convey the scope of the present invention to those skilled in the art. Throughout the disclosure, like reference numerals refer to like parts throughout the various figures and embodiments of the present invention.

Hereafter, a communication blocking control apparatus and method in accordance with an embodiment of the present invention will be described in detail with reference to the accompanying drawings.

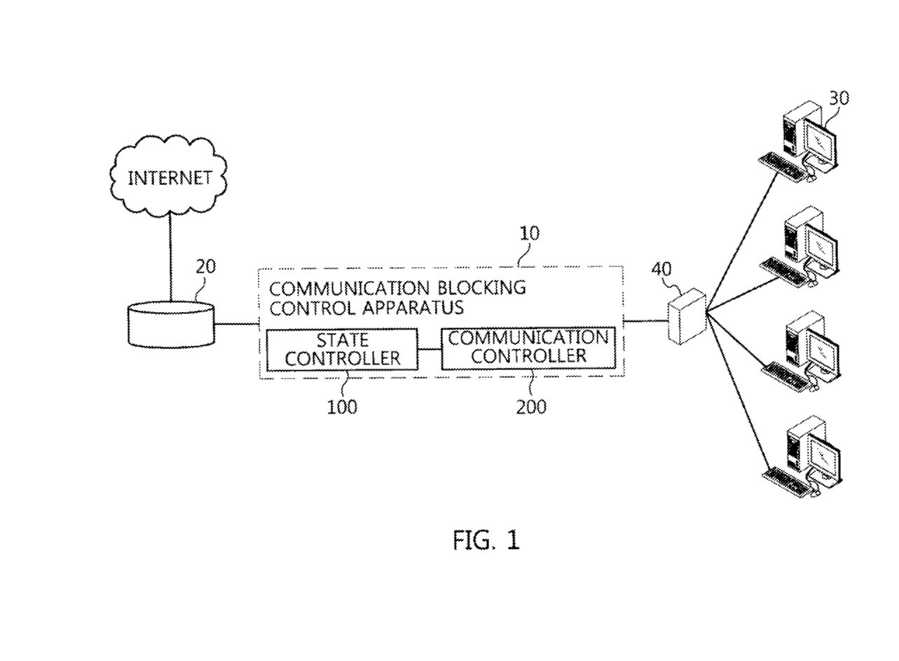

FIG. 1 schematically illustrates an environment to which the communication blocking control apparatus in accordance with the embodiment of the present invention is applied.

Referring to FIG. 1, the environment to which the communication blocking control apparatus in accordance with the embodiment of the present invention is applied includes the communication blocking control apparatus 10, a switch 20, a user's terminal 30, and a hub 40. The switch 20 serves to handle switching between the communication blocking control apparatus 10 and the Internet. The hub 40 serves to handle connections between the terminal 30 and the communication blocking control apparatus 10. Here, an internal network corresponds to a network of the communication blocking control apparatus 10 and the terminal 30, which are connected through the hub 40, and an external network corresponds to a network connected to the Internet through the switch 20.

The communication blocking control apparatus 10 controls the communication state of the terminal 30 through the switch 20, according to whether an idle period of the terminal 30 is applied or not. Here, the idle period corresponds to a period during which it is difficult to find out whether or not information contained in the terminal 30 is leaked, while the user does not use the terminal 30.

For this operation, the communication blocking control apparatus 10 includes a state controller 100 and a communication controller 200.

The state controller 100 is configured to control the state of the terminal 30 according to a request of the terminal 30 which is received through the communication controller 200. Specifically, the state controller 100 registers the state of the terminal 30 as a communication blocked state or cancels the communication blocked state according to a request of the communication controller 200, and transfers a response containing the changed state of the terminal 30 to the communication controller 200.

The communication controller 200 is configured to receive a communication blocking request or communication blocking cancellation request from the terminal 30, transfer the received request to the state controller 100, and transfer a response corresponding to the request transferred from the state controller 100 to the terminal 30.

Specifically, when receiving a communication blocking request from the terminal 30, the communication controller 200 transfers the communication blocking request to the state controller 100. Then, the communication controller 200 receives a response corresponding to the request from the state controller 100, and transfers the received response to the terminal 30.

When receiving a communication blocking cancellation request from the terminal 30, the communication controller 200 generates a CAPTCHA, and receives a CAPTCHA response corresponding to the generated CAPTCHA from the terminal 30. Here, the CAPTCHA includes a test for determining whether or not the communication blocking cancellation request corresponding to a normal communication blocking cancellation request, through a recognition reaction of the user of the terminal 30. Then, the communication controller 200 decides whether or not to transfer the communication blocking cancellation request to the state controller 100, based on the CAPTCHA response.

In accordance with the embodiment of the present invention, the communication controller 200 may perform the communication with the terminal 30 through the hub 40, that is, the communication in the internal network, even when the communication of the terminal 30 in the external network is blocked by an IDS/IPS function of the state controller 100.

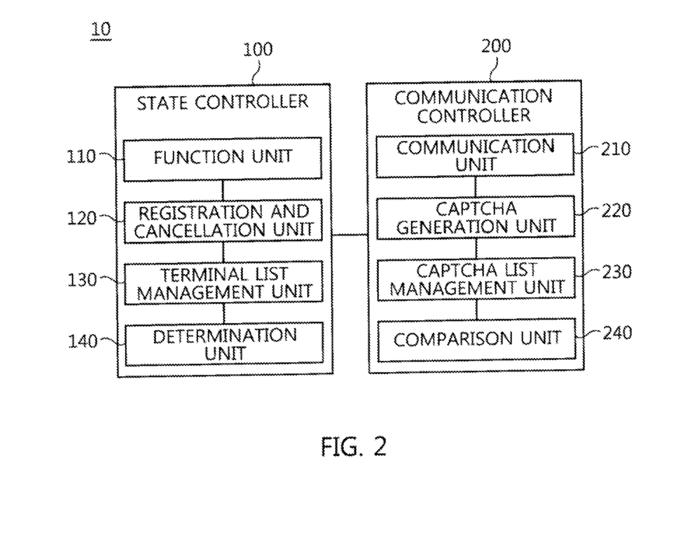

Next, the communication blocking control apparatus 10 will be described in detail with reference to FIG. 2.

FIG. 2 is a configuration diagram of the communication blocking control apparatus in accordance with the embodiment of the present invention.

Referring to FIG. 2, the communication blocking control apparatus 10 includes the state controller 100 and the communication controller 200.

The state controller 100 includes a function unit 110, a registration and cancellation unit 120, a terminal list management unit 130, and a determination unit 140.

The function unit 110 is configured to perform an IDS/IPS function, Here, the IDS function refers to a function of detecting an intrusion to threaten the security of a specific system and actively dealing with the intrusion. In particular, unlike a firewall aiming to block an intrusion, the IDS has various hacking techniques embedded therein. Therefore, the IDS may detect, control, and track an intrusion in real time,

The IPS function refers to a security solution that discovers an attack signature in a network and automatically takes a certain action to block an abnormal traffic. The IPS function is a solution which has a passive defense function but is focused on blocking an attack before an intrusion warning, unlike the IDS function. That is, the IPS includes an intrusion deviation function and an automatic management function. Furthermore, the IPS automatically detects information leakage caused by an abnormal behavior of a corresponding server, and takes an action to prevent the information leakage, thereby controlling the abnormal behavior.

The registration and cancellation unit 120 is configured to register the state of the terminal 30 as a communication blocked state or cancel the communication blocked state, according to a request of the terminal 30. At this time, the registration and cancellation unit 120 receives the request of the terminal 30 through the communication controller 200.

The terminal list management unit 130 is configured to manage a list of terminals 30 which are registered as a communication blocked state by the registration and cancellation unit 120.

The determination unit 140 is configured to determine the state of the terminal 30 based on a packet corresponding to the terminal 30, that is determine whether the terminal 30 is in a communication blocked state or a communication blocking cancellation state.

The communication controller 200 includes a communication unit 210, a CAPTCHA generation unit 220, a CAPTCHA list management unit 230, and a comparison unit 240.

The communication unit 210 is configured to handle communication between the state controller 100 and the terminal 30.

Specifically, the communication unit 210 receives a communication blocking request or communication blocking cancellation request from the terminal 30, and transfers the received request to the state controller 100. Furthermore, the communication unit 210 receives a result obtained by controlling the state of the terminal 30, that is, a response corresponding to the request from the state controller 100, and transfers the response to the terminal 30.

The CAPTCHA generation unit 220 is configured to generate a CAPTCHA including a test for determining whether or not the communication blocking cancellation request received through the communication unit 210 corresponds to a normal communication blocking cancellation request, through a recognition reaction of the user of the terminal 30. Furthermore, the CAPTCHA generation unit 220 transmits an image of the generated CAPTCHA, that is, a CAPTCHA image to the terminal 30, and requests a response corresponding to the transmitted CAPTCHA image.

The CAPTCHA list management unit 230 is configured to manage the CAPTCHA generated by the CAPTCHA generation unit 220 and a correct answer to the test included in the CAPTCHA in a list type.

The comparison unit 240 is configured to compare the correct answer to the test included in the CAPTCHA to a CAPTCHA response received from the terminal 30, and decides whether or not to transfer the communication blocking cancellation request to the state controller 100, based on the comparison result.

Specifically, when the correct answer to the test included in the CAPTCHA is identical to the CAPTCHA response received from the terminal 30, the comparison unit 240 transfers the communication blocking cancellation request to the state controller 100. On the other hand, when the correct answer to the test included in the CAPTCHA is not identical to the CAPTCHA response received from the terminal 30, the comparison unit 240 controls the CAPTCHA generation unit 220 to regenerate a CAPTCHA.

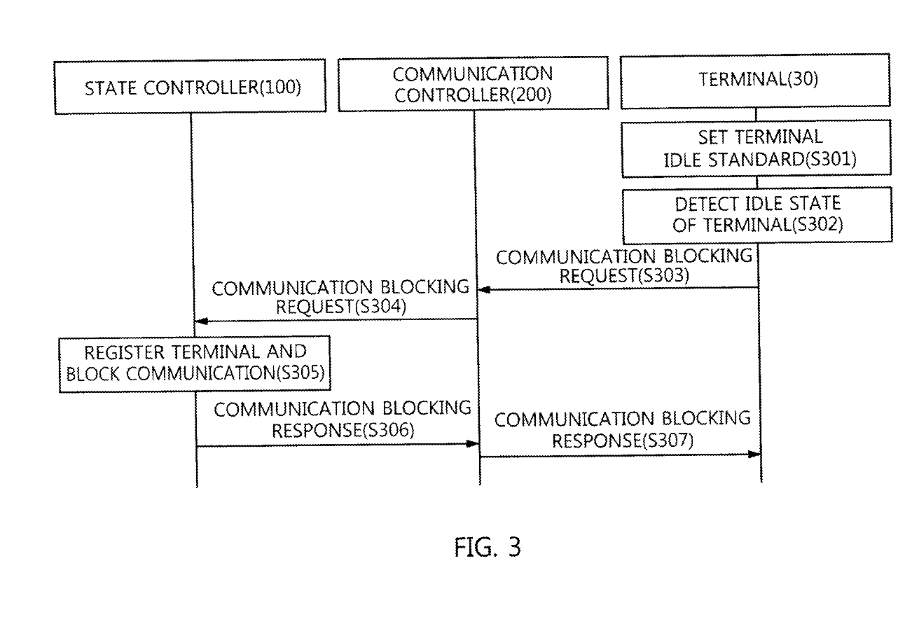

Next, a method in which the communication blocking control apparatus 10 controls a communication blocked state of a terminal will be described in detail with reference to FIG. 3.

FIG. 3 is a flow chart showing the method for controlling a communication blocked state of a terminal in accordance with the embodiment of the present invention.

First, an environment to which the method for controlling a communication blocked state of a terminal in accordance with the embodiment of the present invention is applied includes the state controller 100, the communication controller 200, and the terminal 30.

Referring to FIG. 3, the terminal 30 sets a standard for determining whether the state of the terminal 30 corresponds to an idle state or not, that is, a terminal idle standard at step S301. Here, the idle state refers to a state in which it is difficult to discover whether information contained in the terminal is leaked or not. For example, the terminal idle standard may include a case in which a screen saver of the terminal is operated and a case in which no input is made from a user of the terminal during a preset time

At step S302, the terminal 30 detects an idle state of the terminal, based on the terminal idle standard set at step S301 and makes a communication blocking request to the communication controller 200 at step S303.

The communication controller 200 transfers the communication blocking request of the terminal 30 to the state controller 100 at step S304.

The state controller 100 registers the state of the terminal 30 as a communication blocked state in a communication blocked list according to the communication blocking request received through the communication controller 200, and blocks the communication of the terminal 30 in the external network at step S305.

The state controller 100 transfers a response including the changed state of the terminal 30, that is, a communication blocking response to the communication controller 200 at step S306.

The communication controller 200 transfers the communication blocking response received from the state controller 100 to the terminal 30 at step S307.

In FIG. 3, it has been described that the terminal 30 requests a communication blocking request when the state of the terminal 30 corresponds to an idle state based on the terminal idle standard. However, the user of the terminal 30 may make a communication blocking request according to the user's intention, and the present invention is not limited thereto.

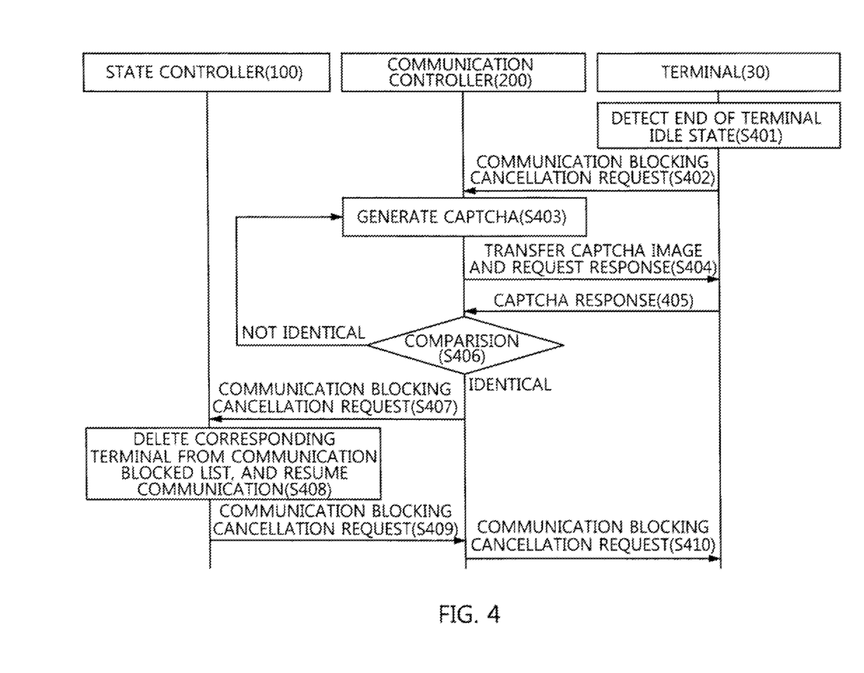

Next, a method in which the communication blocking control apparatus 10 controls a communication blocking cancellation state of a terminal will be described with reference to FIG. 4.

FIG. 4 is a flow chart showing the method for controlling a communication blocking cancellation state of a terminal in accordance with the embodiment of the present invention.

First, an environment to which the method for controlling a communication blocking cancellation state of a terminal in accordance with the embodiment of the present invention is applied includes the state controller 100, the communication controller 200, and the terminal 30.

Referring to FIG. 4, the terminal 30 detects that the idle state of the terminal was ended, based on the preset terminal idle standard, at step S401, and makes a communication blocking cancellation request to the communication controller 200 at step S402.

When receiving a communication blocking cancellation request from the terminal 30, the communication controller 200 generates a CAPTCHA including a test for determining whether the communication blocking cancellation request corresponds to a normal communication blocking cancellation request or not, through a recognition reaction of the user of the terminal 30, at step S403.

Next, the communication controller 200 transfers an image of the CAPTCHA generated at step S403, that is, a CAPTCHA image to the terminal 30, and requests a response to the CAPTCHA image at step S404. At this time, the communication controller 200 manages the CAPTCHA generated at step S403 and a correct answer to the test included in the CAPTCHA in a list type.

The terminal 30 transfers a CAPTCHA response corresponding to the received CAPTCHA image to the communication controller 200 at step S405.

The communication controller 200 compares the correct answer to the test included in the CAPTCHA to the CAPTCHA response received from the terminal 30 at step S405, at step S406.

When the correct answer to the test included in the CAPTCHA is not identical to the CAPTCHA response received from the terminal 30, the communication controller 200 performs control to regenerate a CAPTCHA.

On the other hand, when the correct answer to the test included in the CAPTCHA is identical to the CAPTCHA response received from the terminal 30, the communication controller 200 transfers a communication blocking cancellation request to the state controller 100 at step S407.

The state controller 100 deletes the terminal 30 registered as a communication blocked state from the communication blocked list according to the communication blocking cancellation request received at step S407, and enables the terminal 30 to communicate through the external network at step S408.

After changing the state of the terminal 30 such that the terminal 30 may communicate through the external network as in step S408, the state controller 100 transmits a response corresponding to the communication blocking cancellation request, that is, a communication blocking cancellation response to the communication controller 200 at step S409. Then, the communication controller 200 transfers the communication blocking cancellation response received at step S409 to the terminal 30 at step S410.

In FIG. 4, it has been described that the terminal 30 makes a communication blocking cancellation request when the idle state of the terminal 30 is ended based on the terminal idle standard. However, the user of the terminal 30 may make a communication blocking cancellation request according to the users intention, and the present invention is not limited thereto.

As such, the apparatus and method in accordance with the embodiment of the present invention may fundamentally block the possibility of information leakage during the idle period in which it is difficult for a user to find out whether information contained in the terminal is leaked or not, and the user may make a communication blocking request according to the user's intention. Therefore, since the communication to the outside may be blocked before a communication blocking cancellation request is made, the user may have a right to make a decision for the network use.

In accordance with the embodiments of the present invention, the communication blocking control apparatus and method may fundamentally block the possibility of information leakage during an idle period in which it is difficult for a user to find out whether information contained in the user's terminal is leaked or not. Furthermore, additional rules do not need to be adopted, and the falsification possibility of malignant codes may be prevented through a CAPTCHA. Furthermore, a corresponding terminal may be accessed in the internal network, and may be cured and patched from a remote position.

Furthermore, if necessary, the user may make a communication blocking request according to the user's intention. Therefore, since the communication to the outside may be blocked before a communication blocking cancellation request is made, the user may have a right to make a decision for the network use. Through this operation, as the communication blocked state is maintained while an important document operation is performed, information leakage may be fundamentally blocked.

While the present invention has been described with respect to the specific embodiments, it will be apparent to those skilled in the art that various changes and modifications may be made without departing from the spirit and scope of the invention as defined in the following claims.

What is claimed is:

1. A communication blocking control method comprising:
receiving a communication blocking request from a terminal in an idle state in which it is difficult to find out whether information is leaked or not;
registering a state of the terminal in a communication blocked list according to the communication blocking request; and
blocking external communication of the terminal through a network.

2. The communication blocking control method of claim 1, wherein, in the blocking the external communication of the terminal through the network,
the external communication of the terminal is blocked based on an (Intrusion Detection System)/IPS (Intrusion Prevention System).

3. The communication blocking control method of claim 1, wherein, when a screen saver of the terminal is operated or no input is made from a user of the terminal during a preset time, the terminal determines that the terminal is in the idle state.

4. A communication blocking control method comprising:
receiving a communication blocking cancellation request from a terminal of which an idle state is ended, wherein the idle state corresponds to a state in which it is difficult to find out whether information is leaked or not;
generating a CAPTCHA (Completely Automated Public Turing test to tell Computers and Humans Apart) corresponding to a recognition reaction of a user of the terminal, based on the communication blocking cancellation request;
transferring a CAPTCHA image corresponding to the CAPTCHA to the terminal, and receiving a CAPTCHA response corresponding to the CAPTCHA image;
comparing the CAPTCHA response to a CAPTCHA list corresponding to the CAPTCHA; and
controlling external communication of the terminal through a network, based on a result obtained by comparing the CAPTCHA response to the CAPTCHA list.

5. The communication blocking control method of claim 4, wherein the CAPTCHA comprises a test for determining whether the communication blocking cancellation request corresponds to a normal communication blocking cancellation request or not, through the recognition reaction of the user of the terminal.

6. The communication blocking control method of claim 5, wherein, in the controlling the external communication of the terminal through the network, based on the result obtained by comparing the CAPTCHA response to the CAPTCHA list,
when the CAPTCHA response is included in the CAPTCHA response list, the external communication of the terminal through the network is controlled to be enabled.

7. The communication blocking control method of claim 6, wherein, in the controlling the external communication of the terminal through the network, based on the result obtained by comparing the CAPTCHA response to the CAPTCHA list,
when the CAPTCHA response is included in the CAPTCHA response list, the terminal is deleted from a preset communication blocked list, according to the communication blocking cancellation request.

8. The communication blocking control method of claim 6, wherein, in the controlling the external communication of the terminal through the network, based on the result obtained by comparing the CAPTCHA response to the CAPTCHA list,
the external communication of the terminal through the network is controlled based on an IDS/IPS.

9. A communication blocking control apparatus comprising:
a communication controller configured to receive at least one of communication blocking request and communication blocking cancellation request from a terminal; and
a state controller configured to register a state of the terminal as a communication blocked state or cancel the communication blocked state, according to the request received by the communication controller,
wherein, when receiving the communication Hocking cancellation request, the communication controller generates a CAPTCHA corresponding to a recognition reaction of a user of the terminal, based on the communication blocking cancellation request, receives a CAPTCHA response corresponding to the CAPTCHA from the terminal, and controls external communication of the terminal through a network to be enabled, based on a result obtained by comparing the CAPTCHA response to a CAPTCHA list corresponding to the CAPTCHA.

10. The communication blocking control apparatus of claim 9, wherein, when the request received by the communication controller corresponds to the communication blocking request, the state controller registers the state of the terminal in a communication blocked list according to the communication blocking request, and performs control to block the external communication of the terminal.

11. The communication blocking control apparatus of claim 9, wherein the state controller controls the state of the terminal based on an IDS/IPS.

12. The communication blocking control apparatus of claim 9, wherein the CAPTCHA comprises a test for determining whether the communication blocking cancellation request corresponds to a normal communication blocking cancellation request or not, through the recognition reaction of the user of the terminal.
